(19) United States
(12) Patent Application Publication
(10) Pub. No.: US 2024/0081309 A1
(43) Pub. Date: Mar. 14, 2024

(54) MAIN BODY FRAME AND DUAL BEARING FISHING REEL COMPRISING THE SAME

(71) Applicant: GLOBERIDE, Inc., Tokyo (JP)

(72) Inventor: Keisuke MATSUNO, Tokyo (JP)

(21) Appl. No.: 18/241,046

(22) Filed: Aug. 31, 2023

(30) Foreign Application Priority Data
Sep. 9, 2022 (JP) 2022-144008

(51) Int. Cl. A01K 89/015

(52) U.S. Cl. CPC A01K 89/0193

(57) ABSTRACT

A dual bearing fishing reel according to an embodiment of the present disclosure comprises a spool around which a fishing line is wound, a frame main body comprising a left frame and a right frame in which the spool is disposed, and three or more connecting members for connecting the left and right frames, in which shapes of respective contact surfaces of the connecting members in contact with the left and right frames are the same.

### CROSS-REFERENCE TO RELATED APPLICATION

This application claims priority under 35 U.S.C. § 119 to Japanese Patent Application No. 2022-144008 filed on Sep. 9, 2022 in the Japanese Patent Office, the entire contents of each hereby incorporated by reference.

### FIELD

The present disclosure relates to a main body frame and a dual bearing fishing reel.

### BACKGROUND

Conventionally, various reels have been known as reels in which a left frame portion and a right frame portion supporting both ends of a spool are configured separately. Since the left and right frame portions can be manufactured independently, it has the advantage of being simple and easy to manufacture as compared to one in which the left and right frame portions are integrally formed by molding such as die casting.

As such a reel, for example, JP H6-31459 Y discloses a dual-bearing reel in which a left frame portion (1) and a right frame portion (2) supporting a spool (8) are formed separately, and a coupling body (3) coupling opposing surfaces of the left and right frames (1) and (2) is formed so that outer surfaces thereof are molded in shapes that match or substantially match the shapes of outer surfaces of the frame portions (1) and (2).

### SUMMARY

However, although the left and right frame portions can be formed independently, such a biaxial reel has a structure that needs a plurality of members that connects the left and right frame portions, a special shape corresponding to a fixing position is necessary for each shape of the frame portions and connecting members, manufacturing methods and processing conditions are greatly different. Thus, it takes a lot of processing cost for manufacturing itself of all with high accuracy, the quality and color of appearance are also affected by a difference in manufacturing methods and the like, and there is a problem that additional cost is also necessary for such management.

The present disclosure has been made in view of the above circumstances, and an object thereof is to provide a main body frame and a dual bearing fishing reel including the same in which, by arranging manufacturing methods, shapes, and processing conditions of a plurality of connecting members, accuracy such as the distance, parallelism, and coaxiality between the left and right frames after being assembled to the frame main body is secured only by managing processes of one component, and by making most of molds and manufacturing methods common, manufacturing cost is significantly reduced as compared with a case of individually having a special shape, and a difference in color and quality is less likely to occur for each connecting member and a stable appearance can be achieved at low cost. Purposes of the present disclosure other than this object will be clarified by referring to the overall description disclosed herein.

A dual bearing fishing reel according to an embodiment of the present disclosure comprises a spool around which a fishing line is wound, a frame main body comprising a left frame and a right frame in which the spool is disposed, and three or more connecting members for connecting the left and right frames, in which shapes of respective contact surfaces of the connecting members in contact with the left and right frames are the same.

In the dual bearing fishing reel according to an embodiment of the present disclosure, to prevent exposure of a contact region between the left and right frames and the connecting members to the outside, the connecting members comprise an edge portion that covers the contact surfaces of the left and right frames.

A main body frame according to an embodiment of the present disclosure is a frame main body used for a dual bearing fishing reel, the frame main body comprising a left frame and a right frame in which a spool around which a fishing line is wound is disposed, and three or more connecting members for connecting the left and right frames, in which shapes of respective contact surfaces of the connecting members in contact with the left and right frames are same.

According to the above embodiment, by arranging the manufacturing methods, shapes, and processing conditions of a plurality of connecting members, accuracy such as the distance, parallelism, and coaxiality between the left and right frames after being assembled to the frame main body can be secured only by managing processes of one component, most of molds and manufacturing methods can be made common, and thus the manufacturing cost is significantly reduced as compared with the case of individually having a special shape. Further, the appearance of the pair portions of the connecting members is a common material surface, and thus a difference in color and quality is less likely to occur for each connecting member, so that it is possible to provide a main body frame in which a stable appearance can be achieved at low cost and a dual bearing fishing reel comprising the main body frame.

### BRIEF DESCRIPTION OF THE DRAWINGS

FIG. 1 is a view illustrating a basic configuration of a dual bearing fishing reel according to an embodiment of the present disclosure;

FIG. 2 is a perspective view of a main body frame according to the embodiment of the present disclosure;

FIG. 3 is an exploded perspective view of constituent members of the main body frame according to the embodiment of the present disclosure;

FIG. 4 is a cross-sectional view of the main body frame according to the embodiment of the present disclosure; and

FIG. 5 is a view illustrating a connecting member of the main body frame according to the embodiment of the present disclosure.

### DETAILED DESCRIPTION

Hereinafter, an embodiment of a dual bearing fishing reel according to the present disclosure will be specifically described with reference to the accompanying drawings. Components common in a plurality of drawings are assigned with the same reference signs throughout the plurality of drawings. It should be noted that each of the drawings is not always illustrated in a precise aspect ratio for the convenience of description.

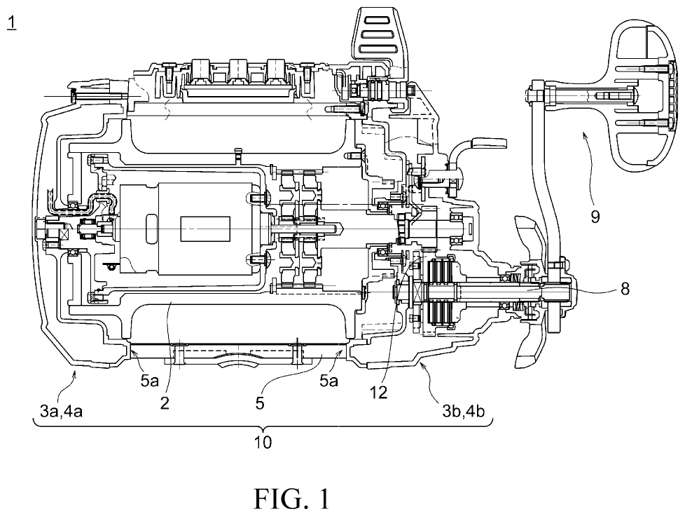

First, a basic configuration of a dual bearing fishing reel 1 according to the embodiment of the present disclosure will be described with reference to FIG. 1. As illustrated in the drawing, the dual bearing fishing reel 1 can wind a fishing line around the spool 2, switch between a state in which the fishing line can be released from the spool 2 and a state in which the fishing line cannot be released from the spool 2, cause the spool 2 to idle when a tension equal to or greater than a set value is applied to the fishing line (drag function), set a threshold tension, and adjust a braking force for preventing backlash during casting (throwing).

As illustrated in FIG. 1, the dual bearing fishing reel 1 comprises a reel main body (a frame main body or a main body frame structure) 10 comprising left and right frames 3a and 3b arranged to be separated from each other in a left and right direction, side plates 4a and 4b covering the left and right frames 3a and 3b, and a plurality of connecting members (in the example illustrated, four connecting members) 5 connecting the left and right frames 3a and 3b.

Note that a set plate (not illustrated) is disposed adjacent to the outer sides of the left and right frames 3a and 3b, and side plates 4a and 4b are attached to the outer sides of the set plate via screws or the like to be described later. Here, in the present specification, a case of the reel main body (frame main body) 10 comprises any of an aspect comprising the left and right frames 3a and 3b described above and the plurality of connecting members 5, an aspect comprising the left and right frames 3a and 3b described above, the plurality of connecting members 5, and the side plates 4a and 4b, and an aspect comprising the left and right frames 3a and 3b described above, the plurality of connecting members 5, the side plates 4a and 4b, and the set plate (not illustrated). The spool 2 is provided between the left and right frames 3a and 3b. A handle shaft 8 is rotatably supported by the right frame 3b and the right side plate 4b, and an operating part 9 (handle 9) is attached to an end of the handle shaft 8.

The left and right frames 3a and 3b are portions forming the framework of the reel main body (frame main body) 10, and are formed of, for example, a metal material such as an aluminum alloy or a magnesium alloy, but are not limited thereto. Further, front frames (not illustrated) are provided on the front sides of the left and right frames 3a and 3b. The front frame (not illustrated) has a tubular shape and is formed of, for example, a metal material such as an aluminum alloy or a magnesium alloy, but is not limited thereto.

Further, a pinion (not illustrated) is disposed at an end protruding from a set plate (not illustrated) of a spool shaft so as to be movable (movable in the axial direction) to an engaged or disengaged position with the spool shaft, and is moved in the axial direction via a clutch mechanism (not illustrated) to connect and disconnect transmission of a driving force. A drive gear 12 attached to the handle shaft 8 is meshed with the pinion (not illustrated), and by rotationally operating the handle 9 attached to the handle shaft 8 in a clutch-ON state, a rotational driving force is transmitted via the drive gear 12 and the pinion, and the spool 2 is rotationally driven.

Next, a structure of the left and right frames 3a and 3b of the dual bearing fishing reel 1 will be further described with reference to FIGS. 1, 2, and 3. The left and right frames 3a and 3b (right frame 3b) have openings (not illustrated) through which the spool 2 can be inserted and removed, and the right frame 3b is circular and has an annular strip shape as a whole (in this case, the left frame 3a on the opposite side may also have the same shape).

The plurality of connecting members 5 (four connecting members 5 in the illustrated example) connecting the left and right frames 3a and 3b are selected so that the dimensions of their end surfaces (contact surface with the left and right frames 3a and 3b) match, for example, an annular strip width of the right frame 3b having an annular strip shape. In this manner, when the connecting members 5 are coupled to the left and right frames 3a and 3b, the support area of the contact portion (contact portion) increases, and the frame structure is strengthened.

The connecting members 5 are coupled to the left and right frames 3a and 3b by, for example, the following configuration. The left and right frames 3a and 3b are provided with recesses 13 into which the ends of the connecting members 5 can be fitted, and are coupled by fitting the ends of the connecting members 5 into the recesses 13. Further, in order to more accurately align the connecting members 5 with the left and right frames 3a and 3b, a positioning member (positioning pin) 14 can be provided on an end surface (contact surface with the left and right frames 3a and 3b) 5a of the connecting members 5, and a hole 15 capable of accommodating the positioning member 14 can be provided in the left and right frames 3a and 3b.

Then, female screw portions 16 are formed in the end surface 5a of the connecting member 5, and the connecting members 5 and the left and right frames 3a and 3b are connected to each other so that, into these portions, male screw portions of screws for attaching outer side plates 5a and 5b and the set plate (not illustrated) to the left and right frames 3a and 3b are screwed. Note that the connecting members 5 may be attached to the left and right frames 3a and 3b by screwing as described above or by crimping.

Since the connecting member 5 and the left and right frames 3a and 3b are not integrally molded, a material having high strength and good appearance can be selected. Specifically, as the material of the connecting members 5 and the left and right frames 3a and 3b, an aluminum alloy, stainless steel, a copper alloy, a titanium alloy, or the like is selected according to target fish, design specifications by fishing method, size of a form, price, and the like, and according to their physical properties, surface treatment can be appropriately performed by performing alumite treatment or plating (Ni, Cr) treatment, or coating a ceramic material such as nitride (TiN or the like), carbide (SiC or the like), or oxide (Al2O3 or the like). As described above, since there is more room for selecting a material, the reel main body (frame main body) 10 having sufficient strength can be manufactured at low cost.

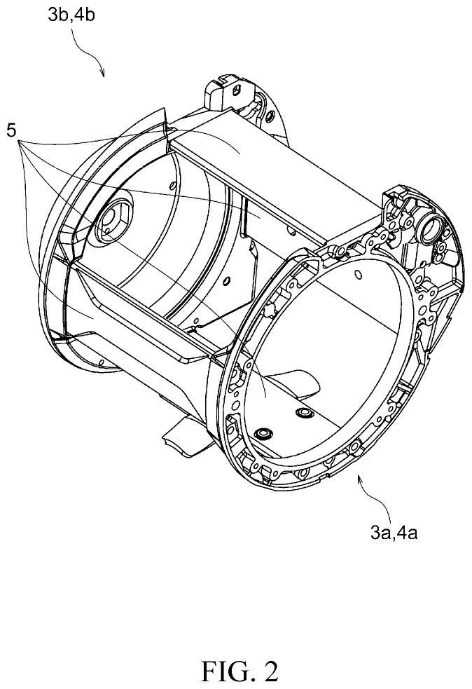

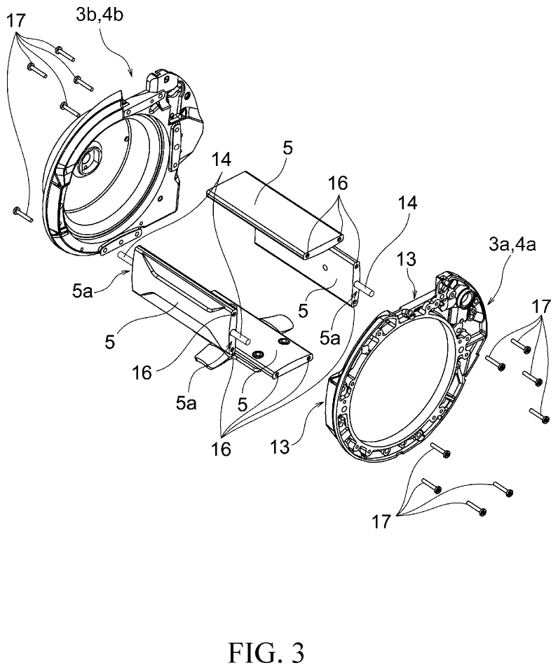

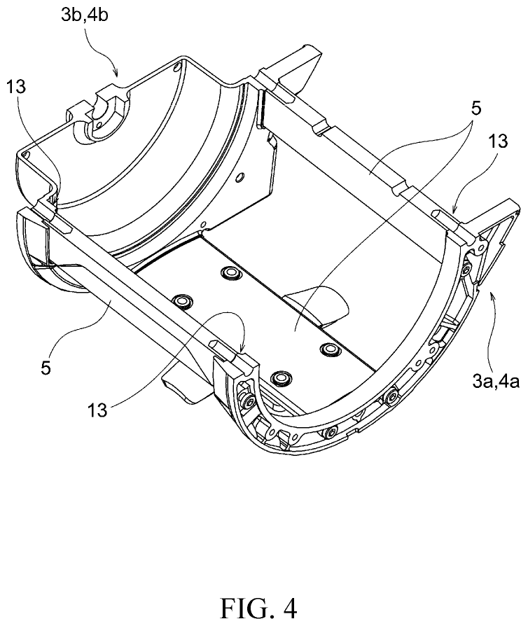

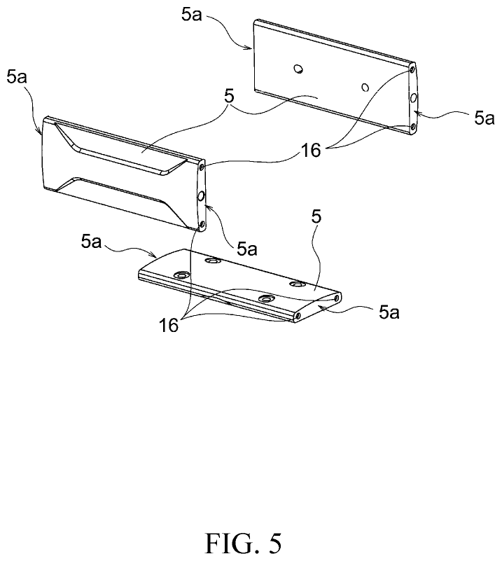

With reference to FIGS. 2 to 5 and FIG. 1 again, a main body frame according to the embodiment of the present disclosure and the dual bearing fishing reel comprising the main body frame will be further described. FIG. 2 illustrates a perspective view of the main body frame according to the embodiment of the present disclosure. FIG. 3 is an exploded perspective view of constituent members of the main body frame according to the embodiment of the present disclosure. FIG. 4 illustrates a cross-sectional view of the main body frame according to the embodiment of the present disclosure. FIG. 5 is a view illustrating a connecting member of the main body frame according to the embodiment of the present disclosure.

As illustrated in the drawing, a main body frame 10 according to the embodiment of the present disclosure is a frame main body 10 used for the dual bearing fishing reel 1 comprising the left and right frames 3a and 3b in which a spool (not illustrated) around which a fishing line is wound is disposed, and three or more connecting members 5 (in the example illustrated, four connecting members 5) for connecting the left and right frames 3a and 3b, and shapes of respective end surfaces (contact surfaces) 5a of the connecting members 5 in contact with the left and right frames are formed in the same shape (the three or more connecting members 5 comprise end surfaces (contact surfaces) 5a having the same shape). Here, the “in the same shape” means that geometric shapes of outer contours forming the contact surfaces and dimensions thereof are the same. Here, the “in the same shape” comprises, in addition to the above, a case where there is an error in a range such as a dimensional tolerance in manufacturing (the same applies throughout the present specification).

In this manner, by arranging the manufacturing methods, shapes, and processing conditions of the plurality of connecting members, accuracy such as the distance, parallelism, and coaxiality between the left and right frames after being assembled to the frame main body can be secured only by managing processes of one component, most of molds and manufacturing methods can be made common, and thus the manufacturing cost is significantly reduced as compared with the case of individually having a special shape. Further, the appearance of the pair portions of the connecting members is a common material surface, and thus a difference in color and quality is less likely to occur for each connecting member, so that it is possible to provide a main body frame in which a stable appearance can be achieved at low cost.

In addition, the dual bearing fishing reel 1 according to the embodiment of the present disclosure comprises a spool 2 around which a fishing line is wound, and a frame main body 10 comprising a left frame 3a and a right frame 3b in which the spool 2 is disposed, and three or more connecting members 5 for connecting the left and right frames 3a and 3b, in which shapes of respective contact surfaces of the connecting members 5 in contact with the left and right frames 3a and 3b are the same (three or more connecting members 5 comprise end surfaces (contact surfaces) 5a having the same shape). Here, as described above, the “shapes are the same” means that geometric shapes of outer contours forming the contact surfaces and dimensions thereof are the same.

In this manner, by arranging the manufacturing methods, shapes, and processing conditions of the plurality of connecting members, accuracy such as the distance, parallelism, and coaxiality between the left and right frames after being assembled to the frame main body can be secured only by managing processes of one component, most of molds and manufacturing methods can be made common, and thus the manufacturing cost is significantly reduced as compared with the case of individually having a special shape. Further, the appearance of the pair portions of the connecting members is a common material surface, and thus a difference in color and quality is less likely to occur for each connecting member, so that it is possible to provide a dual bearing fishing reel in which a stable appearance can be achieved at low cost.

In addition, in the dual bearing fishing reel 1 according to the embodiment of the present disclosure, to prevent exposure of a contact region between the left and right frames 3a and 3b and the connecting members 5 to the outside, the connecting members 5 comprise an edge portion 17 that covers the end surfaces (contact surfaces) 5a of the left and right frames 3a and 3b. Note that the edge portion 17 is formed to define an opening side end region of the recesses 13 to which the ends of the connecting members 5 described above can be connected. In this manner, the edge of the joint portion of the connecting members after machining is prevented from being exposed, and the user does not have to touch the edge even when holding the reel, so that it is possible to prevent an injury.

Dimensions, materials, and arrangements of the components described in this specification are not limited to those explicitly described in the embodiments, and the components may be modified to have any dimensions, materials, and arrangements that may fall within the scope of the present disclosure. In addition, components not explicitly described herein can be added to the described embodiments, or some of the components described in each embodiment can be omitted.

What is claimed is:

1. A dual bearing fishing reel, comprising:
a spool around which a fishing line is wound; and
a frame main body comprising a left frame and a right frame in which the spool is disposed, and three or more connecting members for connecting the left and right frames, wherein
shapes of respective contact surfaces of the connecting members in contact with the left and right frames are same.

2. The dual bearing fishing reel according to claim 1, wherein to prevent exposure of a contact region between the left and right frames and the connecting members to outside, the connecting members comprise an edge portion that covers the contact surfaces of the left and right frames.

3. A frame main body used for a dual bearing fishing reel, the frame main body comprising a left frame and a right frame in which a spool around which a fishing line is wound is disposed, and three or more connecting members for connecting the left and right frames, wherein
shapes of respective contact surfaces of the connecting members in contact with the left and right frames are same.
